(19) United States
(12) Patent Application Publication
(10) Pub. No.: US 2022/0272558 A1
(43) Pub. Date: Aug. 25, 2022

(54) REMOVING ONLY RAT-SPECIFIC ENTRIES FROM MEASUREMENT REPORT LIST BASED ON UPDATED MEASUREMENT CONFIGURATION

(71) Applicant: QUALCOMM Incorporated, San Diego, CA (US)

(72) Inventors: Vishu KUMAR, Bengaluru (IN); Rajendra BILLURE, Bengaluru (IN)

(21) Appl. No.: 17/180,251

(22) Filed: Feb. 19, 2021

(51) Int. Cl. H04W 24/10

(52) U.S. Cl. CPC H04W 24/10; H04W 88/02

(57) ABSTRACT

Various aspects of the present disclosure generally relate to wireless communication. In some aspects, a user equipment (UE) may receive, from a base station, a quantity configuration indicating one or more updated measurement parameters for a specific radio access technology (RAT). The UE may remove, from a measurement report list, only measurement reporting entries for one or more measurement identities that are associated with the specific RAT. Numerous other aspects are described.

### FIELD OF THE DISCLOSURE

Aspects of the present disclosure generally relate to wireless communication and to techniques and apparatuses for removing only radio access technology (RAT)-specific entries from a measurement report list based on an updated measurement configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, a quantity configuration indicating one or more updated measurement parameters for a specific radio access technology (RAT); and removing, from a measurement report list, only measurement reporting entries for one or more measurement identities that are associated with the specific RAT.

In some aspects, a UE for wireless communication includes a memory and one or more processors operatively coupled to the memory, the memory and the one or more processors configured to: receive, from a base station, a quantity configuration indicating one or more updated measurement parameters for a specific RAT; and remove, from a measurement report list, only measurement reporting entries for one or more measurement identities that are associated with the specific RAT.

In some aspects, an apparatus for wireless communication includes means for receiving, from a base station, a quantity configuration indicating one or more updated measurement parameters for a specific RAT; and means for removing, from a measurement report list, only measurement reporting entries for one or more measurement identities that are associated with the specific RAT.

In some aspects, a non-transitory computer-readable medium storing a set of instructions for wireless communication includes one or more instructions that, when executed by one or more processors of a UE, cause the UE to: receive, from a base station, a quantity configuration indicating one or more updated measurement parameters for a specific RAT; and remove, from a measurement report list, only measurement reporting entries for one or more measurement identities that are associated with the specific RAT.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 illustrates an example of a wireless network in which a UE may support different radio resource control communication modes, in accordance with the present disclosure.

FIG. 4 is a diagram illustrating an example associated with removing only radio access technology (RAT)-specific entries from a measurement report list based on an updated measurement configuration, in accordance with the present disclosure.

FIG. 5 is a diagram illustrating an example process associated with removing only RAT-specific entries from a measurement report list based on an updated measurement configuration, in accordance with the present disclosure.

FIG. 6 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

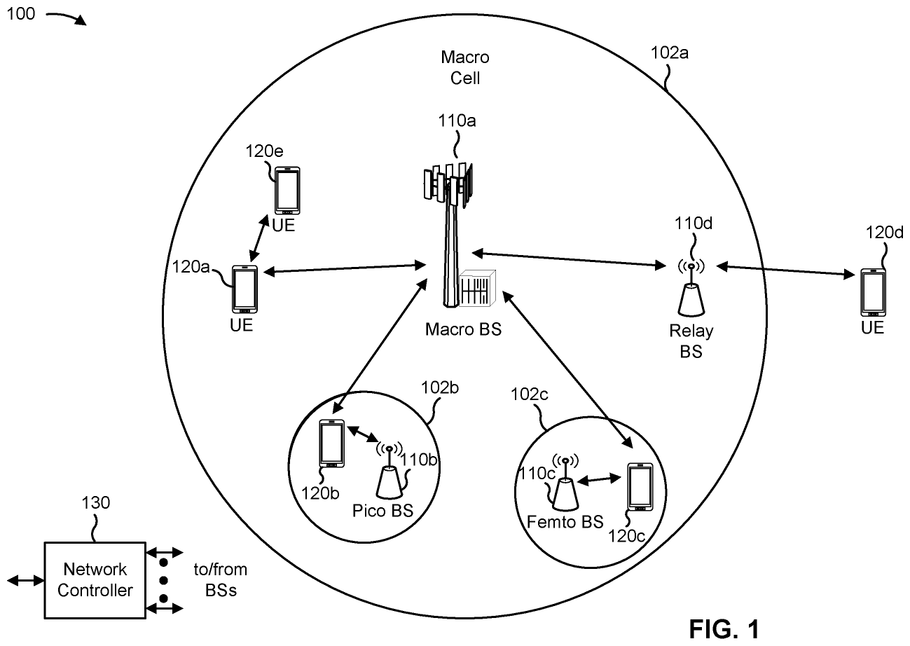

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a BS 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the BS 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

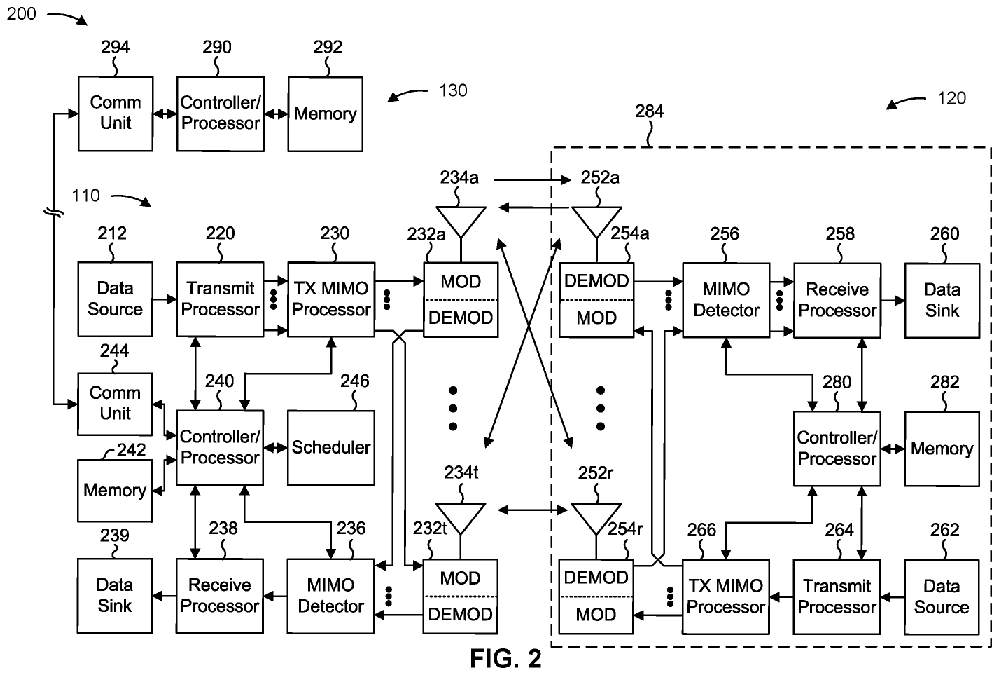

FIG. 2 is a diagram illustrating an example 200 of a BS 110 in communication with a UE 120 in a wireless network 100, in accordance with the present disclosure. BS 110 may be equipped with T antennas 234a through 234t, and UE 120 may be equipped with R antennas 252a through 252r, where in general T>1 and R>1.

At BS 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from BS 110 and/or other BSs and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with B S 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

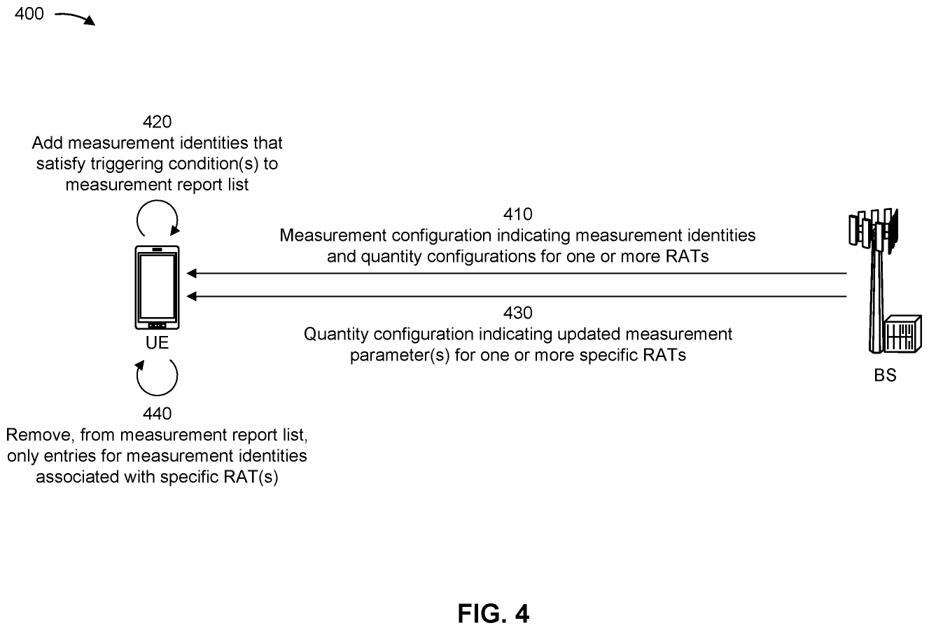

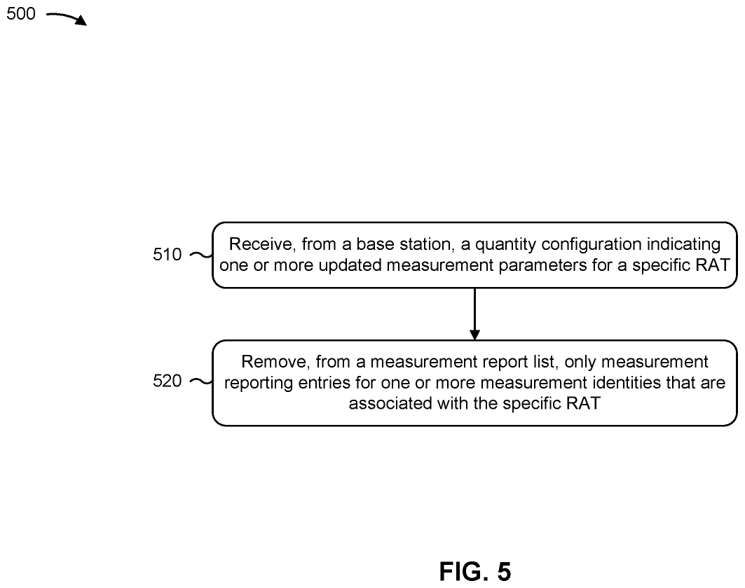

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to BS 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-5.

At BS 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. BS 110 may include communication unit 244 and communicate to network controller 130 via communication unit 244. BS 110 may include a scheduler 246 to schedule UEs 120 for downlink and/or uplink communications. In some aspects, a modulator and a demodulator (e.g., MOD/DEMOD 232) of the BS 110 may be included in a modem of the BS 110. In some aspects, the BS 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-5.

Controller/processor 240 of BS 110, controller/processor 280 of UE 120, and/or any other component(s) of FIG. 2 may perform one or more techniques associated with removing only RAT-specific entries from a measurement report list based on an updated measurement configuration, as described in more detail elsewhere herein. For example, controller/processor 240 of BS 110, controller/processor 280 of UE 120, and/or any other component(s) of FIG. 2 may perform or direct operations of, for example, process 500 of FIG. 5 and/or other processes as described herein. Memories 242 and 282 may store data and program codes for BS 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the BS 110 and/or the UE 120, may cause the one or more processors, the UE 120, and/or the BS 110 to perform or direct operations of, for example, process 500 of FIG. 5 and/or other processes as described herein. In some aspects, executing instructions may include running the instructions, converting the instructions, compiling the instructions, and/or interpreting the instructions, among other examples.

In some aspects, the UE 120 includes means for receiving, from the BS 110, a quantity configuration indicating one or more updated measurement parameters for a specific RAT; and/or means for removing, from a measurement report list, only measurement reporting entries for one or more measurement identities that are associated with the specific RAT. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE 120 includes means for refraining from removing, from the measurement report list, any measurement reporting entries for one or more measurement identities that are associated with a RAT other than the specific RAT associated with the quantity configuration.

In some aspects, the UE 120 includes means for refraining from stopping a reporting timer that is running for any measurement identities in the measurement report list that are associated with a RAT other than the specific RAT associated with the quantity configuration.

In some aspects, the UE 120 includes means for refraining from resetting information associated with one or more measurement identities in the measurement report list that are associated with a RAT other than the specific RAT associated with the quantity configuration.

In some aspects, the UE 120 includes means for receiving, from the BS 110, a measurement configuration that indicates one or more triggering conditions to transmit a measurement report, where each measurement reporting entry in the measurement report list is associated with a measurement identity for which the one or more triggering conditions are satisfied.

In some aspects, the UE 120 includes means for performing one or more measurements for the one or more measurement identities that are associated with the specific RAT based at least in part on the one or more updated measurement parameters indicated in the quantity configuration.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

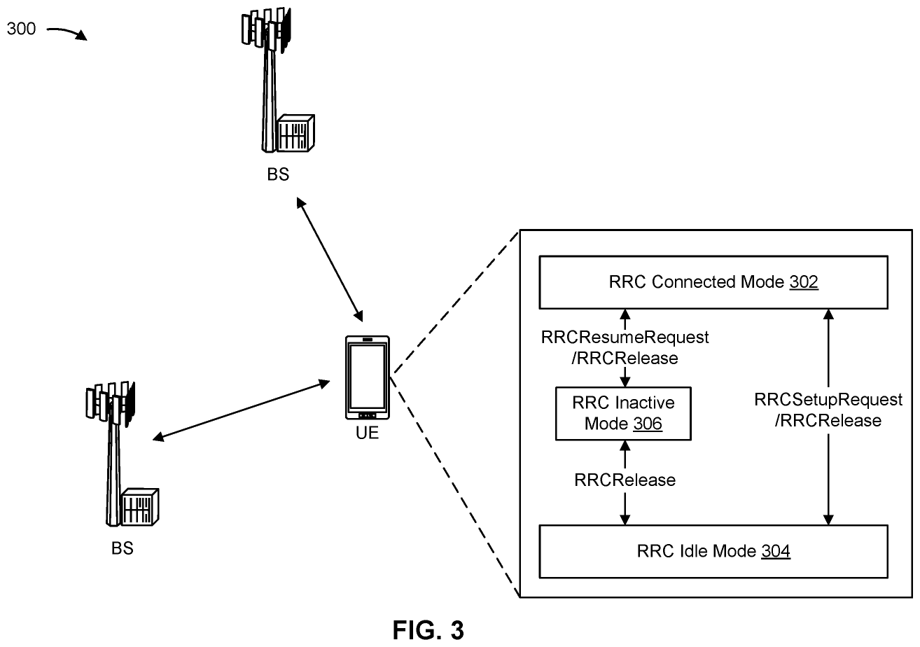

FIG. 3 illustrates an example 300 of a wireless network (e.g., wireless network 100) in which a UE (e.g., UE 120) may support different radio resource control (RRC) communication modes, in accordance with the present disclosure. The UE may be communicatively connected with one or more BSs in the wireless network. For example, the UE may be connected to the one or more BSs in a dual connectivity configuration. In this case, a first BS may serve the UE as a master node and a second BS may serve the UE as a secondary node. Additionally, or alternatively, the first BS may be associated with a serving cell for the UE and the second BS may be associated with a neighbor cell for the UE. Additionally, or alternatively, the first BS may be associated with a first RAT (e.g., NR, LTE, Global System for Mobile Communications (GSM) Enhanced Data rates for GSM Evolution (EDGE) radio access network (GERAN), Wideband CDMA (WCDMA), and/or Universal Terrestrial Radio Access (UTRA), among other examples) and the second BS may be associated with a second RAT.

As illustrated in FIG. 3, the UE may support a connected communication mode (e.g., an RRC connected mode 302), an idle communication mode (e.g., an RRC idle mode 304), and an inactive communication mode (e.g., an RRC inactive mode 306). The RRC inactive mode 306 may functionally reside between the RRC connected mode 302 and the RRC idle mode 304.

The UE may transition between different RRC modes based at least in part on various commands and/or communications received from the one or more BSs. For example, the UE may transition from the RRC connected mode 302 or the RRC inactive mode 306 to the RRC idle mode 304 based at least in part on receiving an RRCRelease communication. As another example, the UE may transition from the RRC connected mode 302 to the RRC inactive mode 306 based at least in part on receiving an RRCRelease with suspendConfig communication. As another example, the UE may transition from the RRC idle mode 304 to the RRC connected mode 302 based at least in part on receiving an RRCSetupRequest communication. As another example, the UE may transition from the RRC inactive mode 306 to the RRC connected mode 302 based at least in part on receiving an RRCResumeRequest communication.

When transitioning to the RRC inactive mode 306, the UE and/or the one or more BSs may store a UE context (e.g., an access stratum (AS) context and/or higher-layer configurations). This permits the UE and/or the one or more BSs to apply the stored UE context when the UE transitions from the RRC inactive mode 306 to the RRC connected mode 302 in order to resume communications with the one or more BSs, which reduces latency of transitioning to the RRC connected mode 302 relative to transitioning to the RRC connected mode 302 from the RRC idle mode 304.

In some cases, the UE may communicatively connect with a new master node when transitioning from the RRC idle mode 304 or the RRC inactive mode 306 to the RRC connected mode 302 (e.g., a master node that is different from the last serving master node when the UE transitioned to the RRC idle mode 304 or the RRC inactive mode 306). In this case, the new master node may be responsible for identifying a secondary node for the UE in the dual connectivity configuration.

In some cases, a BS acting as a master node (e.g., providing a serving cell) for a UE may configure the UE to perform and report measurements when the UE is in the RRC connected mode 302 (e.g., using dedicated signaling, such as an RRCConnectionReconfiguration or an RRCConnectionResume message). For example, the BS may configure the UE to perform intra-frequency measurements (e.g., measurements at one or more downlink carrier frequencies associated with a RAT used in a serving cell), inter-frequency measurements (e.g., measurements at one or more frequencies that are associated with the same RAT as the serving cell and differ from the downlink carrier frequencies used in the serving cell), and/or inter-RAT measurements associated with one or more RATs other than the RAT used in the serving cell. For example, when the UE communicates with the BS using an LTE RAT, the inter-RAT measurements may be performed at NR frequencies, UTRA frequencies, GERAN frequencies, and/or CDMA frequencies, among other examples. In another example, when the UE communicates with the BS using an NR RAT, the inter-RAT measurements may be performed at LTE frequencies, Evolved UTRA (E-UTRA) frequencies, and/or UTRA frequency division duplexing (UTRA-FDD) frequencies, among other examples.

Accordingly, the B S may configure the UE to perform and obtain measurements associated with different RATs in order to support mobility and improved performance for the UE (e.g., to determine whether to initiate a handover to a neighboring cell and/or to a different RAT that may offer better performance than the UE is experiencing in the serving cell). In general, when configuring the UE to perform and obtain measurements, the B S may provide the UE with a measurement configuration that indicates one or more RAT-specific measurement objects (e.g., indicating frequency and/or time resources that the UE is to measure), one or more RAT-specific reporting configurations (e.g., indicating one or more criteria that trigger the UE to send a measurement report and/or the quantities per cell and per beam that the UE is to include in the measurement report), and/or one or more RAT-specific measurement identities that each link one measurement object with one reporting configuration. Additionally, in some aspects, the measurement configuration may include one or more quantity configurations that define measurement parameters and/or measurement filtering configurations to be used for all event evaluation and related reporting of the corresponding measurement.

In some cases, as described above, one or more measurements that the UE is configured to perform and report may be associated with one or more triggering conditions, whereby the UE may transmit a measurement report for the associated measurement(s) when the triggering condition(s) are satisfied. Accordingly, in some cases, a UE may maintain a measurement report list (e.g., associated with the UE variable VarMeasReportList) that includes information about each measurement for which the applicable triggering condition(s) have been met. For example, each entry in the measurement report list may be associated with a measurement identity and a timer that may be started when the applicable triggering condition(s) are satisfied, and the UE may initiate the measurement reporting procedure when the timer expires. In some cases, however, inefficiencies may arise in the measurement reporting procedure when the BS provides an updated quantity configuration to update the measurement parameters associated with one or more RATs.

For example, when a UE receives an updated quantity configuration for any RAT, existing techniques (e.g., as defined in 3GPP Technical Specification (TS) 36.331 and/or 3GPP TS 38.331) specify that the UE has to remove measurement reporting entries associated with all measurement identities from the measurement report list even if the measurement identities are unaffected by the updated quantity configuration. Furthermore, in existing techniques, the UE has to stop whichever timer is running for the measurement identities that are removed from the measurement report list (e.g., a periodic timer, a T321 timer, or a T322 timer) and reset any other information (e.g., a timeToTrigger parameter) that may be associated with the measurement identity. Accordingly, the updated quantity configuration may introduce delays into the measurement reporting procedure (e.g., because measurement identities that are associated with a RAT other than a RAT associated with the updated quantity configuration are unnecessarily removed and re-added to the measurement report list, the associated timers have to be stopped and restarted, and the associated information has to be reset). In addition, in cases where the UE transmitted a measurement report for one or more measurement identities before the measurement identities were deleted from the measurement report list, the UE may end up sending extra (duplicate) reports after the measurement identities are added back to the measurement report list, which introduces additional processing overhead at the UE and the BS and additional network overhead to transport the measurement reports from the UE to the BS.

Some aspects described herein relate to techniques and apparatuses to remove only RAT-specific entries from a measurement report list based on an updated measurement configuration. For example, in some aspects, the UE may receive, from a BS, an updated quantity configuration that indicates one or more updated measurement parameters for a specific RAT (e.g., NR, LTE, GERAN, UTRA, and/or WCDMA, among other examples). Accordingly, the UE may determine whether a measurement report list includes any entries for measurement identities that are associated with the specific RAT associated with the updated quantity configuration, and may remove only the entries in the measurement report list that are associated with the same RAT as the updated quantity configuration. In this way, the UE may refrain from removing any entries in the measurement report list that are associated with a different RAT, may allow the associated timer(s) to continue to run, and may avoid resetting information associated with entries in the measurement report list that are unaffected by the updated quantity configuration. In this way, delays associated with unnecessarily removing, adding, measuring, and reporting the unaffected measurement identities may be removed from the measurement reporting procedure, and time and efficiency may be gained by avoiding a need to stop reporting timers, reset information associated with removed measurement identities, and restarting the reporting timers.

As indicated above, FIG. 3 is provided as an example. Other examples may differ from what is described with regard to FIG. 3.

FIG. 4 is a diagram illustrating an example 400 associated with removing only RAT-specific entries from a measurement report list based on an updated measurement configuration, in accordance with the present disclosure. As shown in FIG. 4, example 400 includes communication between a BS and a UE. In some aspects, the BS and the UE may be included in a wireless network, such as wireless network 100. The BS and the UE may communicate via a wireless access link, which may include an uplink and a downlink.

As shown in FIG. 4, and by reference number 410, the BS may transmit, and the UE may receive, a measurement configuration that indicates measurement identities and quantity configurations for one or more RATs (e.g., via dedicated RRC signaling, such as an RRCConnectionReconfiguration or an RRCConnectionResume message). For example, in some aspects, the UE may communicate with the BS using a particular RAT (e.g., NR or LTE), and the BS may configure the UE to perform and report intra-RAT measurements associated with the RAT that the UE is using to communicate with the BS and/or to perform and report inter-RAT measurements associated with other RATs. In some aspects, the measurement configuration may indicate one or more measurement objects, which generally refer to objects on which the UE is to perform measurements. For example, a measurement object associated with an NR RAT may indicate a frequency and time location and subcarrier spacing of one or more reference signals to be measured and/or a single NR carrier frequency to be measured. In other example, a measurement object associated with an E-UTRA RAT may indicate a single E-UTRA carrier frequency, a measurement object associated with a UTRA RAT may indicate a set of cells on a single UTRA carrier frequency, and/or a measurement object associated with a GERAN RAT may indicate a set of GERAN carrier frequencies, among other examples.

Furthermore, in some aspects, the measurement configuration provided from the BS to the UE may include a list of reporting configurations, where there can be one or more reporting configurations per measurement object. For example, each measurement reporting configuration may indicate one or more reporting criteria, which generally refer to conditions that trigger the UE to send a measurement report. For example, the one or more reporting criteria may indicate that the associated measurement report is to be transmitted periodically and/or based on an event (e.g., a measurement associated with a serving cell satisfying a threshold, a measurement associated with a serving cell failing to satisfy a threshold, a measurement associated with a neighbor cell being better than a measurement associated with the serving cell by an offset, a measurement associated with an inter-RAT neighbor cell satisfying a threshold, and/or the serving cell failing to satisfy a first threshold while a measurement associated with an inter-RAT neighbor cell satisfying a second threshold, among other examples). Furthermore, in some aspects, the reporting configuration may include one or more quantities that the UE is to include in the measurement report and the associated information that the UE is to include in the measurement report.

Accordingly, in some aspects, the measurement configuration provided by the BS may include a list of measurement identities, where each measurement identity links one measurement object with one measurement reporting configuration. In this way, by configuring multiple measurement identities, the BS may link multiple measurement objects to the same reporting configuration and/or may link multiple reporting configurations to the same measurement object. Furthermore, one quantity configuration may be configured per RAT type, where the quantity configuration defines the measurement quantities and associated filtering coefficients to be used for all event evaluation and related reporting of the corresponding RAT type. In general, one filter coefficient can be configured per measurement quantity per RAT type, except for an NR RAT where the BS may configure up to two (2) sets of quantity configurations that each include separate measurement quantity filters for cell and reference signal index measurement results. The UE may therefore maintain, based on the measurement configuration provided by the BS, a single measurement object list, a single reporting configuration list, and a single measurement identities list. The measurement object list may generally include measurement objects that are specified per RAT type, and may include intra-RAT measurement objects (e.g., that correspond to one or more frequencies associated with a RAT used in a serving cell) and/or inter-RAT measurement objects (e.g., that correspond to one or more frequencies associated with a RAT other than the RAT used in the serving cell). Similarly, the list of reporting configurations maintained by the UE may be associated with specific RATs, whereby a measurement identity may link a measurement object to any reporting configuration associated with the same RAT type.

As further shown in FIG. 4, and by reference number 420, the UE may add measurement identities that satisfy applicable triggering conditions to a measurement report list. For example, in some aspects, the UE may perform intra-RAT and/or inter-RAT measurements based on the measurement identities and quantity configurations indicated in the measurement configuration received from the BS. As described above, each measurement identity links one measurement object associated with a specific RAT to a reporting configuration associated with the same RAT. Furthermore, the reporting configuration may define one or more reporting criteria, which may be classified as periodic reporting, event-triggered reporting, cell group identity (CGI) reporting, and/or system frame number and frame timing difference (SFTD) reporting. In general, when a measurement linked to an event-triggered reporting configuration satisfies the applicable condition, the UE may transmit the measurement report to the BS (e.g., to initiate a handover when better performance may be available in a neighbor cell or a cell using a different RAT). However, to avoid excessive measurement reporting for periodic reporting, CGI reporting, and/or SFTD reporting, the UE may maintain a measurement report list that includes the measurement identities that satisfy the applicable conditions. In this case, each measurement identity in the measurement report list may be associated with a timer that is started when the measurement identity satisfies the applicable conditions, and the UE may initiate the corresponding measurement reporting procedure when the corresponding timer expires.

As further shown in FIG. 4, and by reference number 430, the BS may transmit, and the UE may receive, a quantity configuration that indicates one or more updated measurement parameters for one or more specific RATs. For example, in some aspects, the quantity configuration may indicate one or more updated parameters for periodic RAT-specific measurement reporting. In another example, the quantity configuration may indicate one or more updated parameters for CGI reporting, where the BS configures the UE to decode and report a CGI for a set of cells associated with a particular RAT for the purpose of maintain an automatic neighbor relations (ANR) list. In another example, the quantity configuration may indicate one or more updated parameters for SFTD reporting, where the BS configures the UE to measure and report SFTD measurements to enable the BS to derive a time difference of the system frame number (SFN) and frame boundary between the serving cell and one or more target cells, which are particularly useful in dual connectivity scenarios involving multiple RATs. Accordingly, as described herein, the UE may receive the quantity configuration that indicates the one or more measurement parameters while there are one or more entries in the measurement report list (e.g., measurement identities associated with a pending measurement report). However, the quantity configuration may indicate updated measurement parameters associated with one or more specific RATs, and the measurement report list may include entries associated with one or more RATs other than the specific RAT(s) associated with the updated measurement parameters.

Accordingly, as further shown in FIG. 4, and by reference number 440, the UE may remove, from the measurement report list, only one or more measurement reporting entries that correspond to measurement identities associated with the same RAT(s) that are associated with the updated measurement parameters indicated in the quantity configuration. Relatedly, the UE may refrain from removing any measurement reporting entries that correspond to measurement identities associated with a RAT other than the specific RAT(s) associated with the updated quantity configuration. For example, if the UE receives an updated quantity configuration for a GERAN RAT and the measurement report list includes measurement reporting entries associated with an NR RAT, an LTE RAT, the GERAN RAT, and a WCDMA RAT, the UE may remove only the measurement reporting entries that are associated with the GERAN RAT. In this way, the UE may refrain from removing the measurement reporting entries associated with the NR RAT, the LTE RAT, and the WCDMA RAT, which are unaffected by the updated quantity configuration for the GERAN RAT.

Furthermore, as described herein, each measurement reporting entry in the measurement report list may be associated with a running timer, and the UE may initiate the corresponding measurement reporting procedure when the corresponding timer expires. For example, the timer may be a periodic reporting timer, a timer associated with CGI reporting (e.g., a T321 timer that is started upon receiving a measurement configuration including a reporting configuration with a purpose set to reporting a CGI for a set of cells), or a timer associated with reporting SFTD measurements (e.g., a T322 timer that is started upon receiving a measurement configuration including a reporting configuration with a purpose set to reporting SFTD measurements). The UE may therefore refrain from stopping the reporting timer that is running for the measurement identities in the measurement report list that are associated with a RAT other than the RAT associated with the updated quantity configuration, and the UE may further refrain from resetting any information associated with the measurement identities in the measurement report list that are not associated with the same RAT as the updated quantity configuration.

In other words, when the UE receives an updated quantity configuration associated with a specific RAT, the UE may refrain from modifying any entries in the measurement report list that are associated with a different (unaffected) RAT. However, for any measurement reporting entries that are associated with the same RAT as the updated quantity configuration, the UE may remove the measurement reporting entries from the measurement report list, may stop the periodic reporting timer, the CGI reporting timer (e.g., timer T321), or the SFTD reporting timer (e.g., timer T322), whichever is running, and may reset any other information associated with the corresponding measurement identities (e.g., a timeToTrigger parameter that species a time range during which specific criteria have to be met in order to trigger a measurement report). Furthermore, for each RAT for which the quantity configuration received from the B S includes one or more updated measurement parameters, the UE may set the corresponding measurement parameters to the values indicated in the updated quantity configuration and thereafter perform and/or report measurements according to the updated measurement parameters.

Accordingly, by only removing the measurement reporting entries in the measurement report list that are associated with the same RAT as the updated quantity configuration and refraining from removing or otherwise modifying any information or parameters associated with measurement reporting entries associated with other RATs, the UE may remove delays from the measurement reporting procedure that would otherwise occur if the UE were to remove all measurement identities from the measurement report list whenever an updated quantity configuration associated with any RAT is received. For example, the UE may save time by refraining from unnecessarily removing measurement identities in the measurement report list that are tied to a RAT other than the specific RAT associated with the updated quantity configuration and then re-adding, measuring, and reporting the measurement identities that were removed from the measurement report list. Furthermore, by refraining from stopping the reporting timer associated with the unaffected measurement identities that are associated with a different RAT, the UE may conserve time and resources that would otherwise be consumed by stopping the reporting timer(s), resetting the associated information, and/or restarting the reporting timer(s). Furthermore, by maintaining measurement reporting entries associated with a RAT other than the RAT associated with the updated quantity configuration and removing only the measurement reporting entries associated with the same RAT as the updated quantity configuration, the UE may avoid sending duplicate measurement reports, which could otherwise occur if a measurement report corresponding to a measurement identity was sent before the measurement identity was deleted from and then re-added to the measurement report list.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with removing only RAT-specific entries from a measurement report list based on an updated measurement configuration.

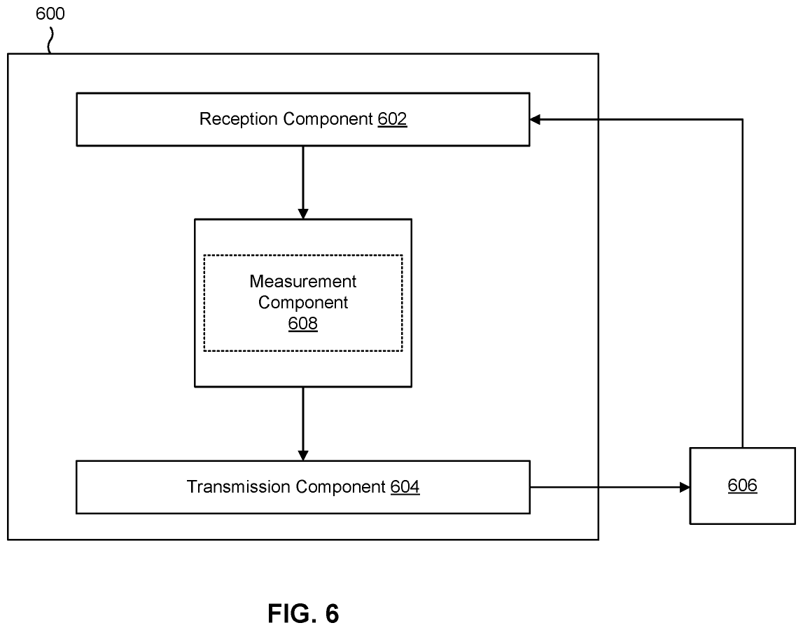

As shown in FIG. 5, in some aspects, process 500 may include receiving, from a base station, a quantity configuration indicating one or more updated measurement parameters for a specific RAT (block 510). For example, the UE (e.g., using reception component 602, depicted in FIG. 6) may receive, from a base station, a quantity configuration indicating one or more updated measurement parameters for a specific RAT, as described above.

As further shown in FIG. 5, in some aspects, process 500 may include removing, from a measurement report list, only measurement reporting entries for one or more measurement identities that are associated with the specific RAT (block 520). For example, the UE (e.g., using measurement component 608, depicted in FIG. 6) may remove, from a measurement report list, only measurement reporting entries for one or more measurement identities that are associated with the specific RAT, as described above.

Process 500 may include additional aspects, such as any single aspect or any combination of aspects described below and/or in connection with one or more other processes described elsewhere herein.

In a first aspect, process 500 includes refraining from removing, from the measurement report list, any measurement reporting entries for one or more measurement identities that are associated with a RAT other than the specific RAT associated with the quantity configuration.

In a second aspect, alone or in combination with the first aspect, process 500 includes refraining from stopping a reporting timer that is running for any measurement identities in the measurement report list that are associated with a RAT other than the specific RAT associated with the quantity configuration.

In a third aspect, alone or in combination with one or more of the first and second aspects, the reporting timer is a periodic reporting timer for the measurement identities that are associated with the RAT other than the specific RAT associated with the quantity configuration.

In a fourth aspect, alone or in combination with one or more of the first through third aspects, the reporting timer is associated with reporting a measurement for a CGI or a measurement for an SFTD for the measurement identities that are associated with the RAT other than the specific RAT associated with the quantity configuration.

In a fifth aspect, alone or in combination with one or more of the first through fourth aspects, process 500 includes refraining from resetting information associated with one or more measurement identities in the measurement report list that are associated with a RAT other than the specific RAT associated with the quantity configuration.

In a sixth aspect, alone or in combination with one or more of the first through fifth aspects, process 500 includes receiving, from the base station, a measurement configuration that indicates one or more triggering conditions to transmit a measurement report, wherein each measurement reporting entry in the measurement report list is associated with a measurement identity for which the one or more triggering conditions are satisfied.

In a seventh aspect, alone or in combination with one or more of the first through sixth aspects, the one or more updated measurement parameters indicated in the quantity configuration specify one or more measurement quantities and filtering coefficients for measurements associated with the specific RAT.

In an eighth aspect, alone or in combination with one or more of the first through seventh aspects, process 500 includes performing one or more measurements for the one or more measurement identities that are associated with the specific RAT based at least in part on the one or more updated measurement parameters indicated in the quantity configuration.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a block diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a measurement component 608, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be co-located with the reception component 602 in a transceiver.

The reception component 602 may receive, from a base station, a quantity configuration indicating one or more updated measurement parameters for a specific RAT. The measurement component 608 may remove, from a measurement report list, only measurement reporting entries for one or more measurement identities that are associated with the specific RAT.

The measurement component 608 may refrain from removing, from the measurement report list, any measurement reporting entries for one or more measurement identities that are associated with a RAT other than the specific RAT associated with the quantity configuration.

The measurement component 608 may refrain from stopping a reporting timer that is running for any measurement identities in the measurement report list that are associated with a RAT other than the specific RAT associated with the quantity configuration.

The measurement component 608 may refrain from resetting information associated with one or more measurement identities in the measurement report list that are associated with a RAT other than the specific RAT associated with the quantity configuration.

The reception component 602 may receive, from the base station, a measurement configuration that indicates one or more triggering conditions to transmit a measurement report, wherein each measurement reporting entry in the measurement report list is associated with a measurement identity for which the one or more triggering conditions are satisfied.

The measurement component 608 may perform one or more measurements for the one or more measurement identities that are associated with the specific RAT based at least in part on the one or more updated measurement parameters indicated in the quantity configuration.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a UE, comprising: receiving, from a base station, a quantity configuration indicating one or more updated measurement parameters for a specific RAT; and removing, from a measurement report list, only measurement reporting entries for one or more measurement identities that are associated with the specific RAT.

Aspect 2: The method of Aspect 1, further comprising: refraining from removing, from the measurement report list, any measurement reporting entries for one or more measurement identities that are associated with a RAT other than the specific RAT associated with the quantity configuration.

Aspect 3: The method of any of Aspects 1-2, further comprising: refraining from stopping a reporting timer that is running for any measurement identities in the measurement report list that are associated with a RAT other than the specific RAT associated with the quantity configuration.

Aspect 4: The method of Aspect 3, wherein the reporting timer is a periodic reporting timer for the measurement identities that are associated with the RAT other than the specific RAT associated with the quantity configuration.

Aspect 5: The method of Aspect 3, wherein the reporting timer is associated with reporting a measurement for a CGI or a measurement for an SFTD for the measurement identities that are associated with the RAT other than the specific RAT associated with the quantity configuration.

Aspect 6: The method of any of Aspects 1-5, further comprising: refraining from resetting information associated with one or more measurement identities in the measurement report list that are associated with a RAT other than the specific RAT associated with the quantity configuration.

Aspect 7: The method of any of Aspects 1-6, further comprising: receiving, from the base station, a measurement configuration that indicates one or more triggering conditions to transmit a measurement report, wherein each measurement reporting entry in the measurement report list is associated with a measurement identity for which the one or more triggering conditions are satisfied.

Aspect 8: The method of any of Aspects 1-7, wherein the one or more updated measurement parameters indicated in the quantity configuration specify one or more measurement quantities and filtering coefficients for measurements associated with the specific RAT.

Aspect 9: The method of any of Aspects 1-8, further comprising: performing one or more measurements for the one or more measurement identities that are associated with the specific RAT based at least in part on the one or more updated measurement parameters indicated in the quantity configuration.

Aspect 10: An apparatus for wireless communication at a device, comprising a processor; memory coupled with the processor; and instructions stored in the memory and executable by the processor to cause the apparatus to perform the method of any of Aspects 1-9.

Aspect 11: A device for wireless communication, comprising a memory and one or more processors coupled to the memory, the memory and the one or more processors configured to perform the method of any of Aspects 1-9.

Aspect 12: An apparatus for wireless communication, comprising at least one means for performing the method of any of Aspects 1-9.

Aspect 13: A non-transitory computer-readable medium storing code for wireless communication, the code comprising instructions executable by a processor to perform the method of any of Aspects 1-9.

Aspect 14: A non-transitory computer-readable medium storing a set of instructions for wireless communication, the set of instructions comprising one or more instructions that, when executed by one or more processors of a device, cause the device to perform the method of any of Aspects 1-9.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station, a quantity configuration indicating one or more updated measurement parameters for a specific radio access technology (RAT); and
removing, from a measurement report list, only measurement reporting entries for one or more measurement identities that are associated with the specific RAT.

2. The method of claim 1, further comprising:
refraining from removing, from the measurement report list, any measurement reporting entries for one or more measurement identities that are associated with a RAT other than the specific RAT associated with the quantity configuration.

3. The method of claim 1, further comprising:
refraining from stopping a reporting timer that is running for any measurement identities in the measurement report list that are associated with a RAT other than the specific RAT associated with the quantity configuration.

4. The method of claim 3, wherein the reporting timer is a periodic reporting timer for the measurement identities that are associated with the RAT other than the specific RAT associated with the quantity configuration.

5. The method of claim 3, wherein the reporting timer is associated with reporting a measurement for a cell global identity (CGI) or a measurement for a system frame number and frame timing difference (SFTD) for the measurement identities that are associated with the RAT other than the specific RAT associated with the quantity configuration.

6. The method of claim 1, further comprising:
refraining from resetting information associated with one or more measurement identities in the measurement report list that are associated with a RAT other than the specific RAT associated with the quantity configuration.

7. The method of claim 1, further comprising:
receiving, from the base station, a measurement configuration that indicates one or more triggering conditions to transmit a measurement report, wherein each measurement reporting entry in the measurement report list is associated with a measurement identity for which the one or more triggering conditions are satisfied.

8. The method of claim 1, wherein the one or more updated measurement parameters indicated in the quantity configuration specify one or more measurement quantities and filtering coefficients for measurements associated with the specific RAT.

9. The method of claim 1, further comprising:
performing one or more measurements for the one or more measurement identities that are associated with the specific RAT based at least in part on the one or more updated measurement parameters indicated in the quantity configuration.

10. A user equipment (UE) for wireless communication, comprising:
a memory; and
one or more processors operatively coupled to the memory, the memory and the one or more processors configured to:
receive, from a base station, a quantity configuration indicating one or more updated measurement parameters for a specific radio access technology (RAT); and
remove, from a measurement report list, only measurement reporting entries for one or more measurement identities that are associated with the specific RAT.

11. The UE of claim 10, wherein the one or more processors are further configured to:
refrain from removing, from the measurement report list, any measurement reporting entries for one or more measurement identities that are associated with a RAT other than the specific RAT associated with the quantity configuration.

12. The UE of claim 10, wherein the one or more processors are further configured to:
refrain from stopping a reporting timer that is running for any measurement identities in the measurement report list that are associated with a RAT other than the specific RAT associated with the quantity configuration.

13. The UE of claim 12, wherein the reporting timer is a periodic reporting timer for the measurement identities that are associated with the RAT other than the specific RAT associated with the quantity configuration.

14. The UE of claim 12, wherein the reporting timer is associated with reporting a measurement for a cell global identity (CGI) or a measurement for a system frame number and frame timing difference (SFTD) for the measurement identities that are associated with the RAT other than the specific RAT associated with the quantity configuration.

15. The UE of claim 10, wherein the one or more processors are further configured to:
refrain from resetting information associated with one or more measurement identities in the measurement report list that are associated with a RAT other than the specific RAT associated with the quantity configuration.

16. The UE of claim 10, wherein the one or more processors are further configured to:
receive, from the base station, a measurement configuration that indicates one or more triggering conditions to transmit a measurement report, wherein each measurement reporting entry in the measurement report list is associated with a measurement identity for which the one or more triggering conditions are satisfied.

17. The UE of claim 10, wherein the one or more updated measurement parameters indicated in the quantity configuration specify one or more measurement quantities and filtering coefficients for measurements associated with the specific RAT.

18. The UE of claim 10, wherein the one or more processors are further configured to:
perform one or more measurements for the one or more measurement identities that are associated with the specific RAT based at least in part on the one or more updated measurement parameters indicated in the quantity configuration.

19. An apparatus for wireless communication, comprising:
means for receiving, from a base station, a quantity configuration indicating one or more updated measurement parameters for a specific radio access technology (RAT); and
means for removing, from a measurement report list, only measurement reporting entries for one or more measurement identities that are associated with the specific RAT.

20. The apparatus of claim 19, further comprising:
means for refraining from removing, from the measurement report list, any measurement reporting entries for one or more measurement identities that are associated with a RAT other than the specific RAT associated with the quantity configuration.

21. The apparatus of claim 19, further comprising:
means for refraining from stopping a reporting timer that is running for any measurement identities in the measurement report list that are associated with a RAT other than the specific RAT associated with the quantity configuration.

22. The apparatus of claim 21, wherein the reporting timer is a periodic reporting timer for the measurement identities that are associated with the RAT other than the specific RAT associated with the quantity configuration.

23. The apparatus of claim 21, wherein the reporting timer is associated with reporting a measurement for a cell global identity (CGI) or a measurement for a system frame number and frame timing difference (SFTD) for the measurement identities that are associated with the RAT other than the specific RAT associated with the quantity configuration.

24. The apparatus of claim 19, further comprising:
means for refraining from resetting information associated with one or more measurement identities in the measurement report list that are associated with a RAT other than the specific RAT associated with the quantity configuration.

25. A non-transitory computer-readable medium storing a set of instructions for wireless communication, the set of instructions comprising:
one or more instructions that, when executed by one or more processors of a user equipment (UE), cause the UE to:
receive, from a base station, a quantity configuration indicating one or more updated measurement parameters for a specific radio access technology (RAT); and
remove, from a measurement report list, only measurement reporting entries for one or more measurement identities that are associated with the specific RAT.

26. The non-transitory computer-readable medium of claim 25, wherein the one or more instructions further cause the UE to:
refrain from removing, from the measurement report list, any measurement reporting entries for one or more measurement identities that are associated with a RAT other than the specific RAT associated with the quantity configuration.

27. The non-transitory computer-readable medium of claim 25, wherein the one or more instructions further cause the UE to:
refrain from stopping a reporting timer that is running for any measurement identities in the measurement report list that are associated with a RAT other than the specific RAT associated with the quantity configuration.

28. The non-transitory computer-readable medium of claim 27, wherein the reporting timer is a periodic reporting timer for the measurement identities that are associated with the RAT other than the specific RAT associated with the quantity configuration.

29. The non-transitory computer-readable medium of claim 27, wherein the reporting timer is associated with reporting a measurement for a cell global identity (CGI) or a measurement for a system frame number and frame timing difference (SFTD) for the measurement identities that are associated with the RAT other than the specific RAT associated with the quantity configuration.

30. The non-transitory computer-readable medium of claim 25, wherein the one or more instructions further cause the UE to:
refrain from resetting information associated with one or more measurement identities in the measurement report list that are associated with a RAT other than the specific RAT associated with the quantity configuration.
